(19) United States
(12) Patent Application Publication
(10) Pub. No.: US 2002/0093535 A1
(43) Pub. Date: Jul. 18, 2002

(54) User interface for character entry using a minimum number of selection keys

(76) Inventor: Michael William Murphy, Manchester, NY (US)

Correspondence Address: Michael W. Murphy, 4 State St., Manchester, NY, 14504, US

(21) Appl. No.: 10/050,201

(22) Filed: Jan. 16, 2002

Related U.S. Application Data
(60) Provisional application No. 60/261,787, filed on Jan. 17, 2001.

(51) Int. Cl. G09G 5/00

(52) U.S. Cl. 345/764

(57) ABSTRACT

Methods and apparatus for character entry, e.g., entry of alphanumeric characters or shorthand symbols, employing fewer hard or soft data entry keys than the number of characters are disclosed. Keyboards are disclosed comprising multiple display windows in which character groups of a defined collection of characters are scrolled through and a character set is simultaneously displayed for in the display windows. The character set is presented for selection in a display window for discrete display time periods either automatically or by user advancement. Users rely upon hand-eye coordination and trainable manual dexterity to “grab” the displayed characters on the fly or in as short a display time as possible. In the automatic scrolling mode, as experience is gained, the user anticipates the presentation of characters of each subset in each display window. Thus, the full collection of characters is presented in space and in time to reduce the time between character selection, and speed and accuracy of data entry are increased.

### RELATED APPLICATION

This application claims priority and other benefits from U.S. Provisional Patent Application Serial No. 60/261,787 filed Jan. 17, 2001, entitled METHOD, APPARATUS AND ORGANIZATION OF A USER INTERFACE FOR CHARACTER ENTRY USING A MINIMUM NUMBER OF SELECTION KEYS.

### FIELD OF THE INVENTION

This invention relates to methods and apparatus for character entry, e.g., entry of alphanumeric characters or shorthand symbols, employing fewer hard or soft data entry keys than the number of characters.

### BACKGROUND OF THE INVENTION

Written human language and numeric or symbolic data entry by a human is commonly accomplished employing a keyboard array of keys representing characters comprising alphanumeric characters, a spacebar, and symbols that are manually struck by the user in formulating text or otherwise entering data. In personal computers and workstations, the keystrokes are translated by word processing or financial or spreadsheet software, for example, and displayed or printed as the message is composed or data is entered. Keys of a keyboard are typically depressed in time sequence to formulate words from individual alphabet characters or to enter numeric values, although most word processing software dictates special cases requiring simultaneous depression of two or more keys to enter dates or shorthand messages or to format text or for other purposes. The keyboard keys and associated characters are visually and tactually distinguished by the human user by their physical, fixed position in the keyboard array.

Current Roman alphabet personal computer keyboards retain key size, spacing and alphanumeric character layout of earlier mechanical and electrical typewriters in large part to accommodate persons trained in usage of the earlier keyboards to perform long taught typing methods at acceptable typing speed and accuracy. As new keys have been required, this traditional keyboard has been further enriched using special keys like “Ctrl” and “Alt” (a different character from ‘x’ is perceived by the computer when ‘Ctrl’ and ‘x’ are pressed at the same time). Furthermore, full point-and-click menu systems have been invented for other special characters. Generally, speed and accuracy of typing using traditional methods decrease as key size and spacing are compressed. Thus, personal computer keyboards are relatively large and in many cases exceed the size of earlier typewriter keyboards typically due to added special purpose keys or splitting apart of keys depressed by the right and left hand fingers.

Miniaturized portable computers, cellular phones, instant messaging devices, pagers, personal digital assistants (PDAs) and other special purpose personal communications equipment are proliferating for performing traditional computing functions and for communicating over telecommunications networks, the World Wide Web via the Internet. Such miniaturized portable devices are considerably smaller physically than personal computer keyboards, and other data entry systems have been devised to enable alphanumeric and data entry.

In one approach, data entry is accomplished using highly miniaturized limited function keyboards having hard keys in a physical keyboard array or soft keys displayed on a screen of the device, and the user is required to compose text or enter data using a pointer manually pressed on the hard or soft key. In other approaches, a limited number of hard or soft keys are provided, and shorthand messages can be composed by selectively. Entering data, composing messages and communicating with other users of such devices is tedious.

The spatial limitations inhibiting usage of the traditional keyboard in such miniaturized equipment have prompted a number of other proposals to increase speed and accuracy of data entry, text composition, and the like, using a lesser number of keys. See for example, U.S. Pat. Nos. 4,737,980, 5,543,818, 5,790,115, 5,812,117, 5,982,351, 6,011,542, 6,021,312, 6,031,471, and 6,104,317. In these approaches, the physical equipment is hardware and/or software modified to enable character selection by the user of displayed characters of full collection of characters or partial collection of characters employing a fewer number of keys than characters in the collection of characters.

Some of these approaches deal with the use of the available key set of the particular device, e.g., the 3×4 standard telephone keyboard (the “980 and '317 patents), video game controllers (the '818 patent), pagers (the '312 patent), television channel remote controllers (the '115 patent), etc. Some of these and others use cursers moved by mouse or up-down and left-right curser movement keys to scroll through displayed characters (the '117, '471, '351, '541 and '542 patents) or to scroll characters through a character position of a word (the '115 patent) arid to select the proper character when it is in the position using a keystroke or mouse click or a pen applied against the displayed or highlighted character.

In one operating mode of the '542 patent, a circular character wheel is displayed on a graphical text entry screen or display, the user rotates the character wheel until a desired character in a particular collection of characters, e.g., the 26 letter alphabet, is in a selection window using a key of the device. The user selects the character using another key or keystroke, and the selected character is displayed in a text entry screen. Scrolling about the entire alphabet is slow and occupies a large part of the display. In another operating mode, only a portion of the full alphabet is depicted on a smaller portion of the display. The user then advances the character wheel to display the desired letter, and it is selected in the same fashion. Only one collection of characters is displayed and scrolled through at any time, and the user has to successively display other collection of characters, e.g numerals or symbols or punctuation marks until a desired set is displayed. A similar approach is described in the '117 patent. Again, this operating mode is inherently slow.

In the '115 patent, the letters of the alphabet and a space in a character spin dial are scrolled by the user manipulating up-down keys to successively display characters in each character position or cell of characters that make up a word that is entered in a text display region of the display. Presumably other characters and punctuation marks and the like can be selected and scrolled through. Again, the process is slow and suited to very limited message entry.

Thus, up to now, character keystrokes have been distinguished primarily by physical position. Every unique character is represented by a unique location of a key of a fixed hard or soft (displayed) keyboard. The user specifies or selects a character by directly pressing a key at a location on the keyboard that is associated with that character or by indirectly selecting via a curser or pressing a pen against a soft key displayed on a screen as described above. Alternatively, as described in certain alternative approaches using fewer entry keys than characters, the user scrolls through software generated and displayed characters and makes a selection when the desired character is presented. There remains an unmet need for improvements in data entry employing a minimum number of character entry keys that increase speed, accuracy, and user convenience.

### SUMMARY OF THE INVENTION

Data entry keyboards are devised in accordance with the present invention that combine a spatial distribution of characters to be selected and entered with 3 time variable. The present invention introduces time as a keyboard variable whereby characters are presented for selection in display windows for discrete display time periods, and users rely upon hand-eye coordination and trainable manual dexterity of the of the user to “grab” the displayed characters on the fly or as quickly as possible. Secondly, keyboards in accordance with the present invention comprise multiple display windows in which character sets of a defined character group are simultaneously displayed. Each character set is presented for selection in a display window for discrete display time periods either automatically or by user advancement. In the automatic scrolling mode, as experience is gained, the user anticipates the presentation of characters of each subset in each display window. Thus, the full collection of characters is presented in space and in time to reduce the time between character selection, and speed and accuracy of data entry are increased.

Although the above two ideas are separate, they are preferably combined to enable a fast and accurate means to select and enter characters using fewer keys than there are unique characters of the character collection. In such a system, character groups of a character collection comprising an alphabet and/or set of numerals and/or symbols and/or punctuation marks are defined. Each character group of characters is repetitively scrolled though a display window for that character group, whereby individual characters of the character group appear in the display window for a brief display time. All the characters that make up an individual character group are assigned to one display window that cycles through each character of the character group over time. Each character group of characters gets a character display window, so there are as many display windows as there are character groups, and a selection key is assigned to each display window. The selection key associated with the particular character display window containing that character is pressed or selected by a curser or any other suitable way by a user at the same time that the desired character is displayed in that display window, and the selected character is entered as data input.

With the addition of time as a keyboard variable, the keyboard of the present invention can be thought of as a two-dimensional matrix with physical position of each display window as a variable on one axis and time as a variable on the other axis. The spatial aspect of the invention introduces the idea of dividing the large collection of characters into character groups recognizable to the user and displaying each character of each character group in a defined user recognizable sequence.

The character groups can be a character group of characters of the 26 letter, Roman alphabet in alphabetical order or in another recognizable order, e.g. rows of the traditional typewriter keyboard. This aspect takes advantage of the user's familiarity with the conventional order of the user's alphabet to minimize the number of characters through which the user must search in order to find a character the user wants.

An example of this method is the division of the letters “a” through “y” of the Roman alphabet into five character groups containing five characters each, with each character group containing a set of five consecutive letters. Note that the most convenient method to display the character groups is ordered such that the character group containing the first five letters of the alphabet comes first, and the character group containing the sixth through the tenth letters comes second, and so on, but this organization is not required.

In searching for a particular letter, a user first typically decides whether that letter is at the beginning, in the middle, or at the end of the alphabet. With this nearly instantaneous assessment, the user can typically cut the search down to one among only one or two character groups of characters. With 5 characters per character group, the search is condensed to a search among only 5 or 10 characters very quickly.

The scrolling rate and the display time can be adjusted by the user so that the user can initially select a slow rate and long display time or can manually scroll the characters through the display windows for each character group as the user learns the technique. Then, the scrolling rate can be increased and the display time decreased to increase speed as the user gains proficiency.

In a further variation, the display windows can be expanded to display the character capable of being selected, the next upcoming or “on-deck” character and the character that has just exited the selection window. In this way, the user rapidly gains familiarity with the character order of each character group and can anticipate the selection of a given on-deck character.

To simplify stringing words or expressions, a separate hard key or soft key can be specified to function as a space bar. As text or other data is “typed” in this way, it is preferably displayed on a screen of the device for editing purposes.

It will be appreciated that the invention is implemented in software routines that can be customized by the user to define the number of display windows and corresponding character groups of characters, the characters in each character group, the order of scrolling of the characters in the character group, the scrolling rate and the display time of each such character group, the hardware or software keys to be employed in selecting characters in the display window, etc.

The user can then load the software and the custom settings into any compatible device, whereby the user enjoys the benefits of a personalized and portable keyboard. In order to facilitate such portability from device to device, keyboard configurations could be downloadable to any system (compact or otherwise) that requires character entry. This would permit users who have become accustomed to their own keyboard on their portable devices or desktop computer to use that same keyboard on any device that they use. Such users could physically or virtually carry an electronic copy of “their” keyboard with them. Their “virtual” keyboard could be downloaded through an Internet or intranet connection into whatever device that they want to use.

Thus, the present invention applies two separate, new ideas to the problem of character entry on devices having fewer keys than there are unique characters. Each of these ideas enable the realization of a character entry system and method of operation that is fast, accurate, and does not require each unique character to have its own selection key.

The present invention provides an efficient method and apparatus for entering alphanumeric, or other, characters into a system or device that has a limited number of keys, especially a compact, portable, or hand-held device, such as a PDA, cellular phone, instant messaging device, or pager. However, the present invention can also be implemented in personal desktop and portable computers or the like as a substitute for or alternative to a conventional keyboard and/or facilitate training in the methods of the invention.

### BRIEF DESCRIPTION OF THE DRAWINGS

Reference is now made to the accompanying detailed drawings of the preferred embodiments in which like reference numerals represent like or similar parts throughout, wherein:

FIG. 1 is a plan view of an exemplary hand-held personal digital assistant or the like having a screen upon which the characters in each character group are scrolled through display windows for selection by the user in entering data;

FIG. 2 is a flowchart illustrating the steps of the automatic display of each character of a character group in a display window for a display time, whereby a character set is displayed during the display time and each displayed character is capable of being selected by the user;

FIG. 3 is an expanded flowchart of the steps of selection of a character displayed in a display window;

FIG. 4 is a flowchart illustrating the steps of displaying each character of a character group in a display window for a display time governed by the user, whereby a character set is displayed during the display time and each displayed character is capable of being selected by the user;

FIG. 5 is an illustration of display windows of character sets, each display window simultaneously displaying a character capable of being selected by the user, a previously displayed character of the character group, and the next to be displayed character of the character group; and

FIG. 6 is an illustration of an optimized array of character groups of a character collection displayed in relation to time.

### DETAILED DESCRIPTION OF THE PREFERRED EMBODIMENTS

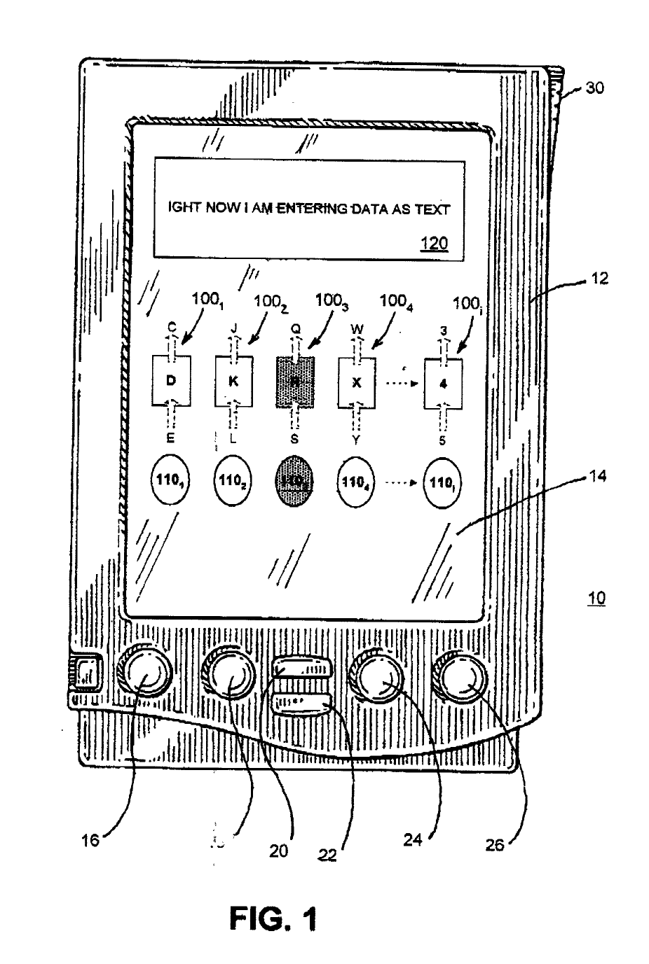

The present invention can be implemented in any data entry device wherein a human user selects characters to formulate text or mathematical expressions or the like to convey information, formulate operating code, make a telecommunication connection or for any reason. Thus, data entry devices comprise any of personal desktop and portable computers, personal digital assistants, portable web access devices, telecommunications devices, etc. For convenience, the preferred embodiments of the present invention are described herein in the context of entering text into a personal digital assistant (PDA) and the like illustrated generally in FIG. 1.

In FIG. 1, the PDA 10 (illustrated in U.S. Design Pat. D397,679) comprises a case 12 enclosing the battery and micro-computer based operating system, and supporting an electronic display 14, e.g., a pressure sensitive LCD screen, keys 16-26, and ports (not shown) along the sides of case 12 for making connections with other equipment in a manner well known in the art. Operating programs, e.g., word processing and spreadsheet programs, can be loaded into memory of the PDA operating system for use by the user. A wand or pen 30 slipped into a holder along a side of the PDA case 12 is also employed by the user to enter data or initiate program controlled functions by pressing the pen tip upon displayed icons or fields of the screen 14 that are detected by the operating system in a manner well know in the art.

FIG. 1 also depicts a first embodiment of an apparatus and method of character-by-character data entry of the present invention. The apparatus of the present invention is realized when an algorithm of the present invention is loaded as a program into the operating system of the PDA 10 or other device of the types listed above. Thus, a user of any such programmable device as PDA 10 would load the program into the device memory or purchase the device having the program already installed and develop a personalized and portable keyboard as summarized above and described further herein.

The screen 14 therefore depicts a plurality of display windows 1001, 1002, 100₃ . . . 100ᵢ, where i is the total number of character display windows. A collection of characters, e.g., the Roman alphabet, is sub-divided into i character groups and are scrolled through the display windows 100₁, 100₂, 100₃ . . . 100ᵢ. Each displayed character is displayed for a predetermined or user selected display time t. A like plurality of soft selection keys 110₁, 110₂, 110₃ . . . 110ᵢ, are displayed and each can be depressed to select a character displayed in the corresponding character display window 100₁, 100₂, 100₃ . . . 100ᵢ, e.g., by use of pen 30. While the soft keys 110₁, 110₂, 110₃ . . . 110ᵢ are depicted as displaced from the corresponding display window 100₁, 100₂, 100₃ . . . 100ᵢ1, it will be understood that they can be superimposed over the display windows 100₁, 100₂, 100₃ . . . 100ᵢ. While soft keys 110₁, 110₂, 110₃ . . . 110ᵢ are employed to make the selection or grab the character in the display window 100₁, 100₂, 100₃ . . . 100ᵢ, it will be understood that the same function could be performed by i software designated hard keys among hard keys 16-26.

The program detects when the user has made a selection of a character displayed in a display window 100₁, 100₂, 100₃ . . . 100ᵢ, and that character is entered into the data stream. In this particular application, the data stream comprises letters of text, and those letters and at least the most recent portion of the text are displayed in text window 120 on display 14. In this way, a user may select characters as they are displayed in the display windows 100₁, 100₂, 100₃ . . . 100ᵢ and compose text. The text can be saved or transmitted remotely or printed out or the like.

One useful collection of characters therefore comprises word processing alphanumeric characters and punctuation marks enabling data entry of human language text and mathematical expressions. Usually, word processing requires entering a space between words and mathematical expressions, capitalizing or otherwise formatting words or text, backspacing, erasing, a return key operation to format paragraphs and the like. It is contemplated that such operations could be made software created soft keys displayed on display 14 and/or specific designations of the hard keys 16-26.

FIG. 1 shows, for example, the formation of the text “RIGHT NOW I AM ENTERING TEXT AS DATA”, where the letter R appearing in display window 100₃ is selected by depressing soft key 110₃ and in the process of being entered so that it will appear in the text window 120 to complete the word “RIGHT”. The display window 100₃ and soft key 110₃ are highlighted showing this selection, and, in practice, it may well be desirable to color highlight the selection as a visual aid to the user.

FIG. 1 also shows the direction of advancement of the characters of each character group through the display windows 100₁, 100₂, 100₃ . . . 100ᵢ. The “just passed” and “on-deck” characters of each character group are also shown in FIG. 1 to show a character order and would not be visible in this preferred embodiment. However, they could be made visible in variations of the preferred embodiments as described further below.

It is of primary importance when dividing the characters of an alphabet or other related set of characters into character groups to consider associations between the characters. Shrewd division of the characters enables the user to take advantage of familiar relationships between characters to help the user find a desired character based on the location of another character, and the relation between the two. An example of this technique is to take advantage of most English-speakers' familiarity with the conventional order of the letters of the Roman alphabet. By placing letters into character groups in the order they appear in the alphabet, and by placing character groups in the order that the letters they hold appear in the alphabet, users can quickly locate an un-displayed letter based on the letters that are displayed, and their knowledge of where some letters fall in the alphabet relative to others. The general form of this embodiment is the following.

First define n as the total number of characters in the alphabet, i as the total number of character groups, and j as the total number of characters per character group. Divide the alphabet by inserting the first j characters of the alphabet into the first character group x₁. Continue by dropping the next j characters of the alphabet into the second character group x₂, the next j characters into x₃, and so on, until the last j or fewer characters are dropped into xᵢ. Inside each character group, the letters should remain in the same order that they were in the original, whole alphabet.

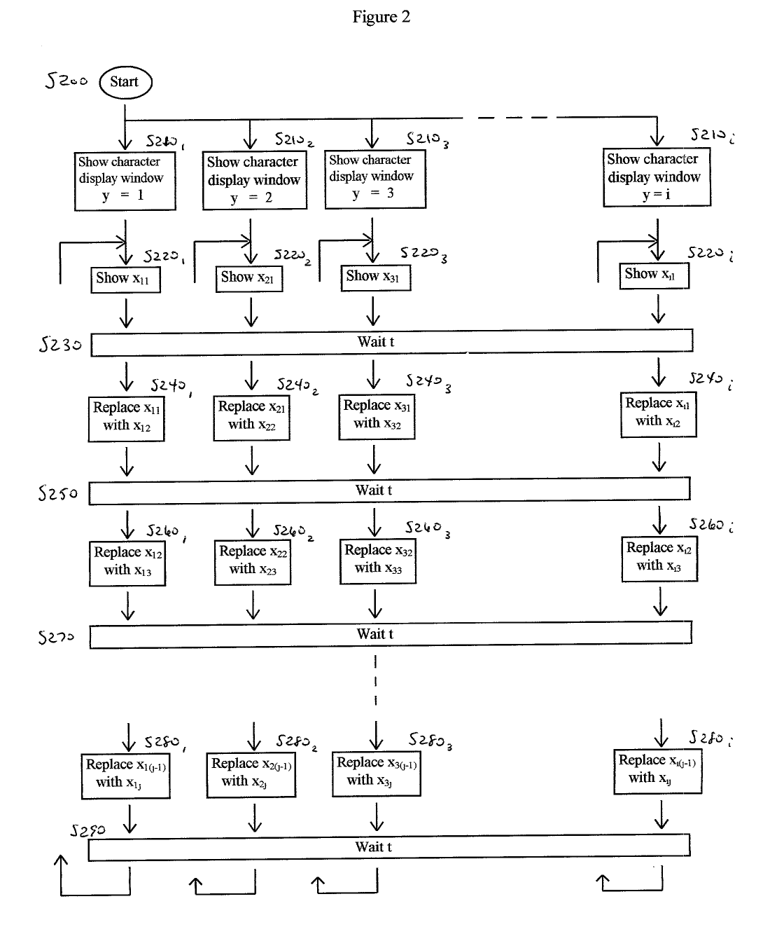

FIG. 2 demonstrates how the j characters within the i character groups of the divided character collection described above would be scrolled though the i display windows 100₁, 100₂, 100₃ . . . 100ᵢ, of FIG. 1. The user starts the program in step S200. In steps S210₁, S210₂, S210₃. . .S210ᵢ, the i character display windows 100₁, 100₂, 100₃ . . . 100ᵢ, as well as any other soft keys including the soft keys 110₁, 110₂, 110₃ . . . 110ᵢ, are displayed on display 14. The first character x₁₁, x₂₁, x₃₁, . . . xᵢ₁ in each character group is then displayed in the respective character display windows 100₁, 100₂, 100₃ . . . 100ᵢ in respective steps S220₁, S220₂, S220₃. . . S220ᵢ for a display time t. The user can enter a command to adjust the display time employing a software designated hard key 16-26 of the PDA 10, for example. When the scrolling of characters is automatic, the selection of the display time essentially establishes a fixed display rate.

When the display time t elapses, the first characters x₁₁, x₂₁, x₃₁ . . . xᵢ₁ are replaced by the second characters x₁₂, x₂₂, x₃₂ . . . xᵢ₂ in their respective character display windows 100₁, 100₂, 100₃ . . . 100ᵢ as shown in steps S240₁, S240₂, S240₃ . . . S240ᵢ. These characters x₁₂, x₂₂, x₃₂ . . . xᵢ₂ are displayed in their respective character display windows 100₁, 100₂, 100₃ . . . 100ᵢ for the display time t in step S250 until they are replaced by the characters x₁₃, x₂₃, x₃₃ . . . xᵢ₃ as shown in steps S260₁, S260₂, S260₃ . . . S260ᵢ, which are in turn displayed for a time t as shown in step S270. This process repeats until steps S280₁, S280₂, S280₃ . . . S280ᵢ and step S290 are completed whereby all j characters in the i character groups have been displayed. At this point, the algorithm returns to steps S220₁, S220₂, S220₃ . . . S220ᵢ, and the entire cycle repeats.

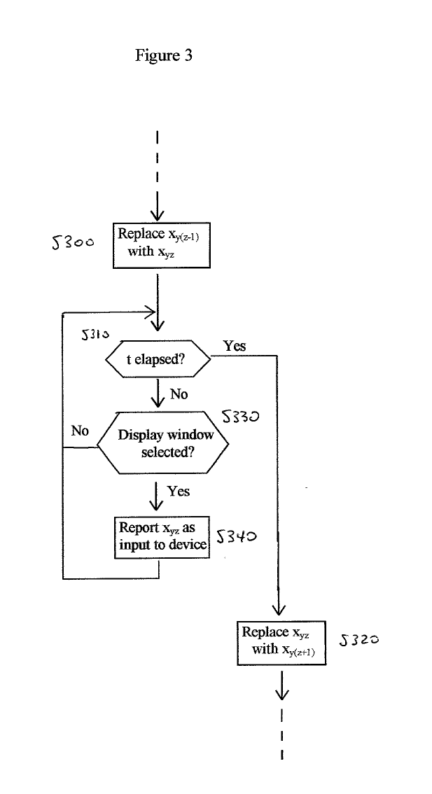

This repetitive display of the j characters in the i character groups in the display windows 100₁, 100₂, 100₃ . . . 100ᵢ during the display time t continues indefinitely until halted by the user at any time during the cycle. The user can select a character that is being displayed in any of the display windows 100₁, 100₂, 100₃ . . . 100ᵢ during the display time t by depressing a hard or soft key as described above with reference to FIG. 1. The entry of the selection of a displayed character in any of the display windows 100₁, 100₂, 100₃ . . . 100ᵢ during any of the display steps S230, S250, S270, . . . S290 of FIG. 2 is depicted in FIG. 3. Step S300 shows the action of a character being replaced by a new character, but for only one character display window. This action is identical to S220, S240, S260, or 280, or any other replacement action in FIG. 2, except that only one display window is shown.

In FIG. 3, the question is asked in step S310 whether display time t has expired. If display time t has expired, step S320 depicts the replacement of the character x_{yz} by the next character in the group, x_{y(z+1)}. Until the display time t expires, step S330 asks the question of whether the selection key associated with that character display window is pressed. If the selection key is depressed, then the character x_{yz} currently displayed in the display window is entered in step S340 and displayed in text area 120 of FIG. 1 or otherwise stored in data memory or otherwise employed. The time-out of the display time t continues, and theoretically user could select another character in one of the other display windows depending on the display time t and adeptness of the user.

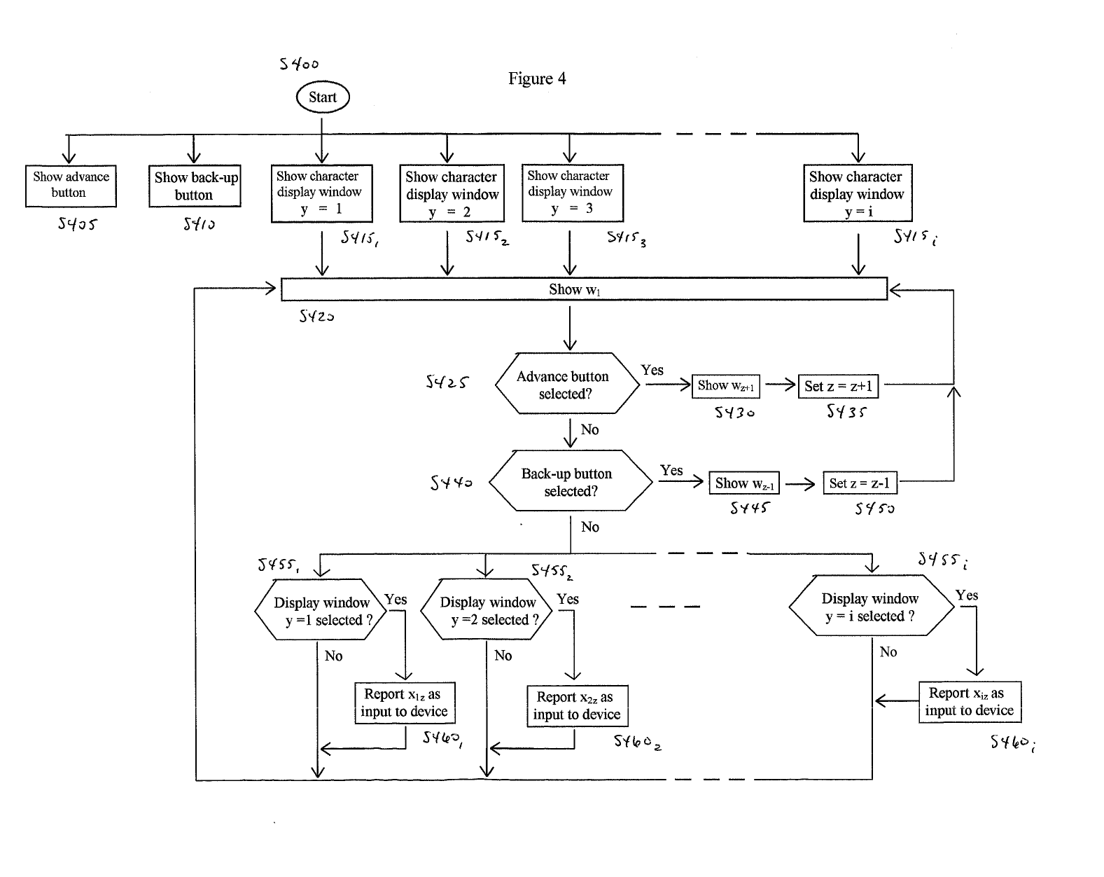

FIG. 4 illustrates an alternative character selection and entry method wherein the user controls when characters are replaced in the display windows, rather than selecting a fixed display time t. Additional soft keys can be displayed on display 14 or the hard keys 20 and 22 of the PDA 10 can be designated to perform an advance function to advance the next character into each display window or a back-up function to return the preceding character into each display window.

The algorithm is commenced by the user in step S400, and, in the soft key variation, the advance key and back-up soft key are displayed on display 14 in steps S405 and S410. The i character display windows 100₁, 100₂, 100₃ . . . 100ᵢ as well as any other soft keys including the soft keys 110₁, 110₂, 110₃ . . . 110ᵢ are displayed on the screen 14 in steps S415₁, S415₂, S415₃ . . . S415ᵢ, respectively. The first character x₁₁, x₂₁, x₃₁, . . . xᵢ₁ in each character group is then displayed in the respective character display windows 100₁, 100₂, 100₃ . . . 100ᵢ in step S420.

As a short cut, all the characters that hold identical positions and would be displayed at the same time in the display windows but are in different character groups are characterized as a “character set”. Thus, a character set is identified by w_{z}, where z is the number of the position in the character groups that the characters of the character set occupy. As an example, in step S420 all the first characters from all the different character groups are called the character set w₁.

Step S420 shows the action of displaying the first character set w₁. Step S425 asks the question of whether the advance key is pressed. If the answer is “YES”, character set wz is replaced with the next character set, w_{z+1}, as shown in step S430. Step S435 then sets z=z+1 in order to register that the character set displayed has advanced by one, and action then returns to S25 again.

If the answer to the question of step S425 is “NO”, then step S440 asks the question of whether the back-up key is pressed. If the answer is “YES”, character set w_{z} is replaced with the previous character set, w_{z-1}, as shown in step S445. In the case that the displayed character set is the first one, w₁, then w₁ is replaced by the very last character set wⱼ. In other words, the character set is scrolled backward down to the last character set. Step S450 then sets z=z−1 in order to register that the character set displayed has backed up by one, and action returns to step S425 once again.

If the answer asked in step S440 was “NO”, then steps S455₁, S455₂, S455₃ . . . S455ᵢ ask the question of whether any of the selection keys are pressed. The character displayed in the display window associated with the pressed selection key is entered and displayed or stored in memory or otherwise processed in any case where the answer is “YES”. The algorithm returns to step S425 once the entry of any selected characters is completed, if any were selected. The algorithm of FIG. 4 loops continuously until the user decides to halt it, which the user can do at any point.

In this manner, a collection of characters, e.g., an alphabet, can be divided into character groups corresponding to the display windows. Then either by device-regulated continuous advancement, or by the user using an advance key, individual characters from each group can be sequentially displayed in their associated character display window. In the typical case of greater than one character display window, the individual characters in each character display window advance together as a character set, similar to the way all the digits of an odometer would roll over together from 99,999 to 00,000. Typically all the characters within each group have an equal display time in their respective character display windows. After a display window has displayed each of its characters once, the cycle repeats itself, and repeats continuously until the user stops it. A character is selected by pressing the selection hard or soft key associated with a particular character display window at the same time that the desired character appears in that display window.

Several variations to these embodiments are possible. One special case is the situation where not all the character groups have the same number of characters. For this special case, the character groups could either be left with an uneven number of characters, or special punctuation characters or spacing or the like could be added to make the character groups equal in number as suggested above. Another approach would be to group the more frequently used characters together in a character group having a lesser number than the number of characters assigned to the remaining groups so that certain of the characters would appear more often in the display window while the other characters cycle through their respective display windows once. Another approach would be to include a given character in more than one character group or more than once per character group. As with the last special case, this causes that character to appear more frequently, and could be a useful option for more frequently selected characters while making all of the character groups equal in number of characters.

A further variation that exists only for the continuously scrolling keyboard is one in which individual display windows can advance at different rates. Taking this option to its extreme, all display windows could have user-selectable distinct scrolling rates.

Returning to the observation made above with respect to FIG. 1, it would be possible to simultaneously display a character capable of being selected by the user, a previously displayed character of the character group, and the next to be displayed character of the character group. The display windows can be expanded so that the “just passed” character and the “on-deck” character of each character group can also be displayed in respective “just passed” and “on-deck” character display windows. The “just passed” and “on-deck” character display windows can bracket the display window holding a character capable of being selected by the user (the “select” character display window).

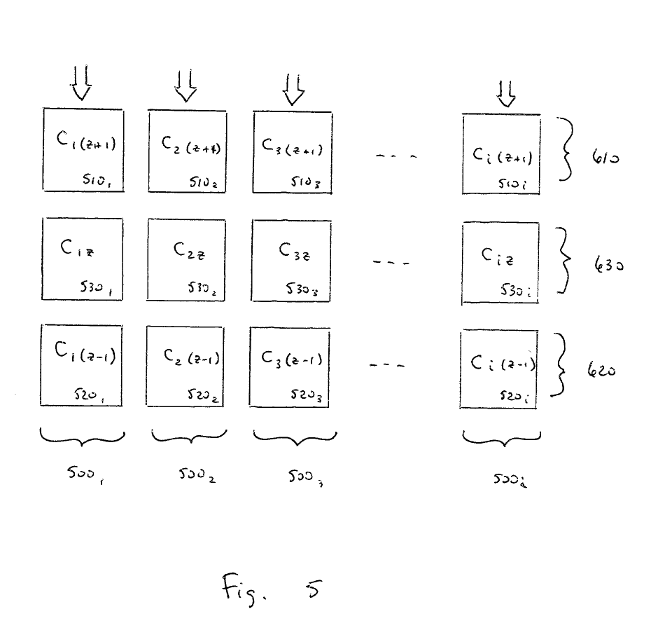

For example, character display windows 500₁, 500₂, 500₃ . . . 500ᵢ are illustrated in FIG. 5, wherein characters of each character group are normally advanced downward first into an “on-deck” display window row 510, then into a “select” display window row 530 and then into a “just passed” display window row 520. The “ondeck” display window row 510 comprises i discrete “on-deck” display windows 510₁, 510₂, 510₃ . . . 510ᵢ. The “just passed” display window row 520 comprises i discrete “just passed” display windows 520₁, 520₂, 520₃ . . . 520ᵢ. The “select” display window row 530 comprises i discrete “select” display windows 530₁, 530₂, 530₃ . . . 530ᵢ. For the case where the character set w_{z}, is displayed in the “select” character display window row 530, the character set w_{z+1} would appear in the “on-deck” display window row 510 and the character set w_{z-1} would appear in the “just passed” display window row 520.

The usefulness of the “on-deck” display window is that it allows the user to anticipate the advancement of a particular character or a given character group into the “select” display window for that character group. One consequence of inclusion of this option is that it speeds up character entry. By watching the “on-deck” display, the user can anticipate the selection key to press while the particular character is still in the “on-deck” display window. By the time the selection decision is made and the selection key is pressed, the desired character has entered the “select” display window so that the desired character actually becomes selected. This feature allows the user to reduce the display time t as he/she gains proficiency, thereby improving character entry speed.

One practical advantage of the “just passed” display window is that it allows the user to stop searching for a character if it has just passed through its “select” display window and is seen in the “just passed” display window. The user knows to stop looking for that missed character and to wait for it to come around into the “select” display window again. With incorporation of a freeze key and a back-up key, passed characters can also be brought back to the “select” window display, if desired.

A freeze key also permits selection of more than one character from the characters then being simultaneously displayed in the display windows, without having to wait for the desired characters of the character groups to cycle back into the display windows.

Variations to these embodiments that decrease the number of display windows also exist. Indication of the character set available for selection can be made by a light or sound message to the user, rather than visual display of the character set itself. In this embodiment, character sets are assigned uniquely pitched beeps or uniquely colored or positioned lights (for example LED lights). When a particular character set is displayed, the unique light or sound assigned to that character set is emitted by the device in order to tell the user the particular character set is up for selection. In the best case, all display windows could be removed, and an experienced user could enter characters using just the light or sound indicator, and their knowledge of the arrangement of the alphabet. This would permit the entire screen of the device to be available for work without expending any screen space for keyboard display.

The selection and constitution of character groups of a collection of characters can be optimized to maximize speed and accuracy of data entry by a user. The following specific selection and constitution of character groups is singled out for the Roman alphabet, or other alphabets or character collections having between about 9 and 45 characters, because it is particularly conducive to fast and accurate character entry while at the same time maintaining the benefit of still having a minimum number of keys. The reason that this arrangement is especially advantageous is that it is an exceptionally good compromise between the opposing requirements of short character search times, fast error recovery, and a minimum number of keys.

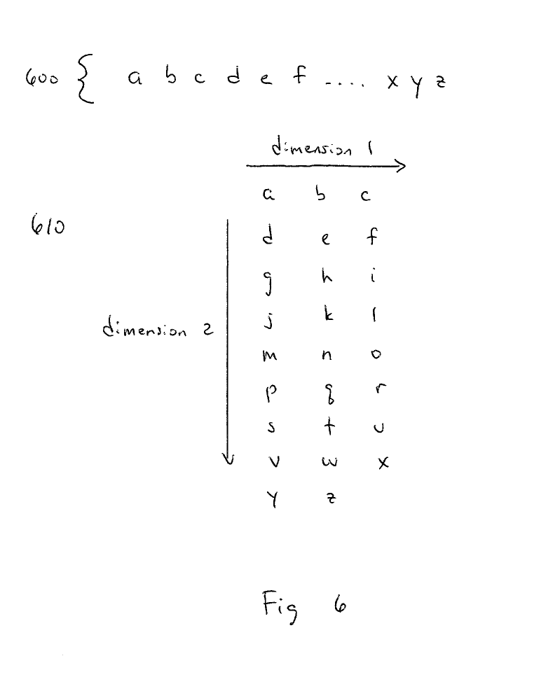

The characters of whatever alphabet or collection of characters is being used are first arranged one dimensionally in the order that they are customarily associated, shown for the Roman alphabet in the array 600 of FIG. 6. A ‘3×n/3’ array 610 of FIG. 6 illustrates a division of the alphabet so that there are three characters per character group (j=3), and n/3 character groups (i=n/3). This array 610 is referred to as the ‘3×3/n’ array because the characters 600 are arrayed in a two-dimensional matrix, with 3 elements in one dimension (dim 1), and n/3 elements in the other dimension (dim 2).

The variable of time, particularly display time t is introduced in the present invention to facilitate data entry via characters in devices having a limited amount of physical space available for character selection keys as described above. Thus, in accordance with the invention, the variable of time is ascribed to one dim 1 or dim 2 in order to reduce the number of selection keys needed. In order to keep scrolling time to a minimum, the shorter dimension (dim 1) is selected to be the time axis in FIG. 6 and the longer dimension (dim 2) is the character location axis. This dictates that it is highly advantageous if nine character display windows are provided, providing nine character sets of three characters each (with a blank or space in the character set including “y” and “z”). Three successive characters display times or 3×t constitute the total repetitive cycle display time along dim 1. The character display times can be automatically created in the automatic scrolling mode or can be user controlled with manual advance and back-up keys.

Two primary advantages are evident from the ‘3×n/3’ array 610 of FIG. 6: (1) a character of any character group is never more than one character away from entering the display window; and (2), in manual mode, if the user accidentally presses the advance or back-up key in the wrong direction, the user need only press the same key again to bring the character back into the display window for selection. Both of these circumstances occur because the character groups contain exactly three characters.

In general, this search technique takes advantage of the fact that every human user knows the order of characters of the alphabet or numerals and knows approximately in which segment of the alphabet or number set any letter or number can be found. Users employing the Roman alphabet know that ‘d’ is near the beginning of the alphabet, and the letters ‘e’ and ‘f’ follow ‘d’. A user who cannot see ‘d’ being displayed in a display window but can see ‘e’ or ‘f’ being displayed in the display window can press the advance key once or twice and ‘d’ will appear in the display window where ‘e’ and ‘f’ were previously displayed or can wait for the letter ‘d’ to be automatically advanced into the display window.

As discussed above, the two-dimensional keyboard makes it possible to specify a character from a group of n characters using fewer than n keys by using a two-tier selection: the selection key pressed, plus the time that it was pressed. A variation on this that is well suited to the 3×n/3 arrangement replaces the time variable with a simultaneous keystroke, such as a shift key.

In this embodiment, all the characters of a character group that were previously displayed sequentially are displayed simultaneously in a single character display window. In the 3×n/3 arrangement this can be thought of as the combination of the selection window, the on-deck window, and the just-passed window, for each character group, into single display windows. In order to select from the character set formerly found in the on-deck window, the advance key is held down while the appropriate selection key is pressed. To select from the just-passed character set, the back-up key is held down while the appropriate selection key is pressed. Characters from the character set formerly found in the selection window are selected by pressing the selection key without any shift key pressed. In this manner, all the advantages of alphabetical division and fewer keys are still enjoyed, with the added benefit that all characters of the alphabet are displayed.

Although it is preferable to position character display windows so that the relative position of each window corresponds to the order that characters are normally thought to occur, the position of character display windows can also be adapted to conform to pre-existing arrangements of hard keys. By way of example, character display windows may be arranged so as to directly superimpose onto the keys of the conventional telephone keypad. In this embodiment, for the Roman alphabet, the conventional organization of the keypad dictates that there are three characters per character group. Character sets scroll as described above, and selection of a character is made by pressing the appropriate number key at the same time that the desired character is indicated as being in the selectable character set. One convenient method to indicate the selectable character set is to make the characters normally shown on each button of the telephone able to be illuminated. For each key, the character that is available for selection by pressing that key is the one that is illuminated. Advancement through the character sets can be made by either manual or automatic advancement. A further variation on this embodiment is to use the shift key embodiment to advance or back up the character set available for selection.

All patents and printed publications disclosed hereinabove are hereby incorporated by reference herein into the specification hereof, each in its respective entirety.

The preceding specific embodiments are illustrative of the practice of the invention. Although only a few exemplary embodiments of the present invention have been described in detail above, those skilled in the art will appreciate readily that many modifications are possible in the exemplary embodiments without materially departing from the novel teachings and advantages of the invention. It is to be understood, therefore, that other expedients known to those skilled in the art or disclosed herein and all such modifications may be employed without departing from the invention or the scope of the appended claims.

1. A method of character-by-character data entry that is displayed on a screen through sequential selection of characters of a collection of characters by a human user comprising:
providing a plurality of display windows on the display;
defining character groups of the collection of characters, each character group to be displayed in a display window on a time variable basis;
successively displaying the characters of each character group in each respective display window for a display time to the user for selection, whereby a character set is simultaneously displayed to the user in the respective plurality of display windows;
detecting the selection by the user of a character displayed in a display window; and
entering the detected character, whereby a user may select characters as they are displayed in the display window and enter data.

2. The method of claim 1, wherein characters comprise word processing alphanumeric characters and punctuation marks enabling data entry of human language text and mathematical expressions.

3. The method of claim 1, wherein step of displaying the characters of each character group in each respective display window comprises simultaneously displaying a character capable of being selected by the user, a previously displayed character of the character group, and the next to be displayed character of the character group.

4. The method of claim 1, wherein the user defines the number of the display windows in the step of defining a plurality of display windows.

5. The method of claim 4, wherein the user defines the character group in the step of defining character groups.

6. The method of claim 1 further comprising the step of defining a character display time for display of each character of each character group in each display window;

7. The method of claim 1, wherein the user defines the character display time in the step of defining the character display rate and display time.

8. The method of claim 1, wherein the character groups preferably comprise no more than three characters.

9. A user operable data entry system for entering data in a data set by selection of characters from a defined collection of characters comprising:
a data entry display screen;
a plurality of character display windows on said data entry display screen for displaying characters;
means for dividing the collection of characters into a like plurality of character groups each having a further plurality of characters arranged in a predetermined order;
means for scrolling the characters of the characters of each character group through a respective character display window such that a character set is displayed in the display windows for a display time;
means for selecting a character displayed in a display window during the display time for entry; and
means responsive to the selection for entering the selected character in a data set.

10. The system of claim 9, wherein the scrolling means comprises means operable by the user for reversing the direction of advancement of a character of each character group into the display window for the character group.

11. The system of claim 9, wherein the scrolling means comprises:
means for displaying a character of the character set in each display window for a display time;
means for timing out the display time; and
means for replacing the character displayed in the display window with the next character in the predetermined order of the characters or each character group upon expiration of the display time.

12. The system of claim 9, further comprising means operable by the user to halt the timing out of the display time and freeze the character display in a display window.

13. The system of claim 9, wherein the scrolling means comprises means operable by the user for scrolling a character of each character group into the display window for the character group.

14. The system of claim 9, wherein the character displaying means for displaying the characters of each character group in each respective display window comprises means for simultaneously displaying a character capable of being selected by the user, a previously displayed character of the character group, and the next to be displayed character of the character group.

15. The system of claim 9, further comprising means operable by the user to define the number of the display windows of the means for defining a plurality of display windows.

16. The system of claim 9, further comprising means operable by the user to define the character set of each character group.

17. The system of claim 9, further comprising the means operable by the user for step of defining a character display time for display of each character of each character group in each display window;

18. The system of claim 9, wherein the character groups preferably comprise no more than three characters.

19. The system of claim 9, further comprising an advance key usable to advance a character into a character display window in first direction for selection and a back-up key to return a character into a character display window that has advanced in the first direction past the display window.

20. The system of claim 9, further comprising a freeze key usable to halt character scrolling and a back-up key to return a character into a character display window that has left the display window.
